(19) United States
(12) Patent Application Publication
(10) Pub. No.: US 2023/0002034 A1
(43) Pub. Date: Jan. 5, 2023

(54) SYSTEM FOR FIXED-PITCH LIFT CONFIGURED FOR USE IN AN ELECTRIC AIRCRAFT

(71) Applicant: BETA AIR, LLC, SOUTH BURLINGTON, VT (US)

(72) Inventor: Kyle B. Clark, Underhill, VT (US)

(73) Assignee: BETA AIR, LLC, SOUTH BURLINGTON, VT (US)

(21) Appl. No.: 17/365,419

(22) Filed: Jul. 1, 2021

(51) Int. Cl. B64C 13/04; B64D 27/24; B64C 11/00; B64C 29/00; B60L 50/60; B64C 5/06; G05D 1/10

(52) U.S. Cl. CPC B64C 13/04; B64D 27/24; B64C 11/00; B64C 29/00; B60L 50/60; B64C 5/06; G05D 1/102; B60L 2200/10

(57) ABSTRACT

In an aspect, a system for fixed-pitch lift configured for use in an electric aircraft includes a plurality of flight components mechanically coupled thereto, each configured to provide lift to the electric aircraft. The electric aircraft also includes a first pusher mechanically coupled to a first owing of the electric aircraft, wherein the first pusher is configured to provide forward flight to the electric aircraft, a second pusher mechanically coupled to a second wing of the electric aircraft, wherein the second pusher is configured to provide forward flight to the electric aircraft as well, a sensor that is configured to detect vertical lift and forward flight from a pilot control and generate a command datum, as a function of the pilot control, a flight controller which may include a computing device configured to receive the command datum and direct the electric aircraft, as a function of the command datum.

### FIELD OF THE INVENTION

The present invention generally relates to the field of electric aircraft lift. In particular, the present invention is directed to a system for fixed-pitch lift configured for use in an electric aircraft.

### BACKGROUND

In the lift of an electric vertical take-off and landing (eVTOL) aircraft, a key component is the electric aircraft's electric propulsion systems that provide thrust for the electric aircraft. However, the technology of eVTOL aircraft is still lacking in crucial areas for efficient vertical lift off and forward flight. This poses a particularly problematic obstacle in not only lift and flight of eVTOL aircraft, but also range and efficiency of the eVTOL aircraft.

### SUMMARY OF THE DISCLOSURE

In an aspect, a system for fixed-pitch lift configured for use in an electric aircraft includes a plurality of flight components mechanically coupled to the electric aircraft, wherein each flight component is configured to provide lift to the electric aircraft. The electric aircraft also includes a first pusher mechanically coupled to a first wing of the electric aircraft, wherein the first pusher is configured to provide forward flight to the electric aircraft. The electric aircraft further includes a second pusher mechanically coupled to a second wing of the electric aircraft, wherein the second pusher is configured to provide forward flight to the electric aircraft as well. The electric aircraft includes a sensor that is configured to detect vertical lift and forward flight from a pilot control and generate a command datum, as a function of the pilot control. The electric aircraft includes a flight controller which may include a computing device configured to receive the command datum, allocate torque to the flight components, and direct the electric aircraft, as a function of the command datum.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary illustration of an embodiment of an electric aircraft with an integration of an electric propulsion assembly;

FIG. 2 is an illustrative embodiment of a system with aircraft components configured for use in electric aircraft for fixed-pitch flight in block diagram form;

FIG. 3 is an exemplary embodiment of an ideal flight datum of torque allocation presented in block diagram form;

FIG. 4 is block diagram illustrating an exemplary embodiment of a machine-learning process; and

FIG. 5 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

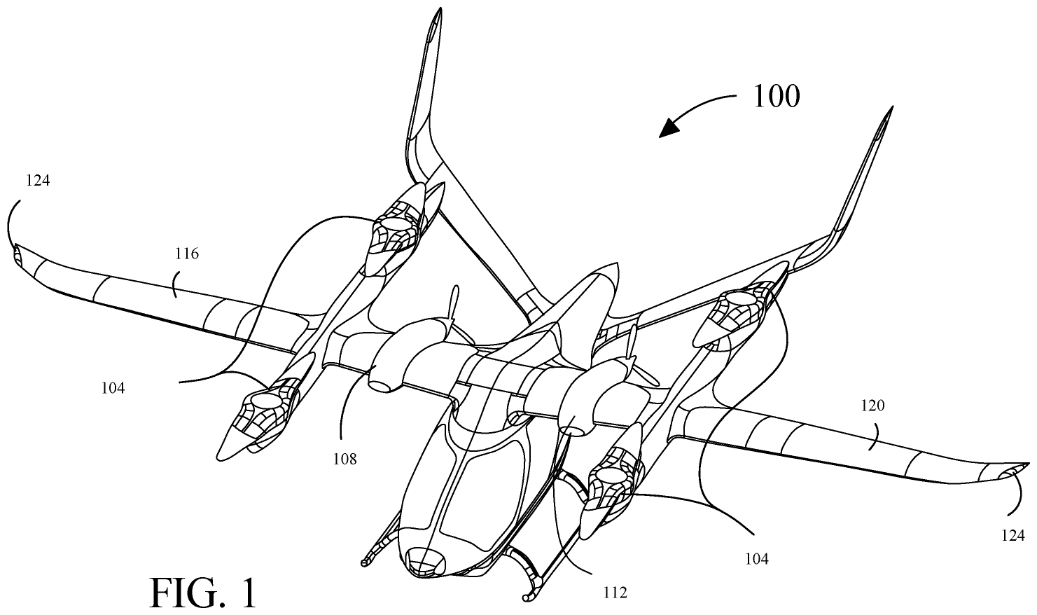

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

At a high level, a system for fixed-pitch lift configured for an electric aircraft, which may be an electric vertical take-off and landing aircraft (eVTOL), and its mechanically coupled flight components is disclosed. The system may be powered only by electricity. System may serve to provide faster or efficient vertical lift off or forward flight or a combination thereof. Each flight component coupled with the electric aircraft may include a propulsor which may further include a rotor, propeller, or a combination thereof, among others. The electric aircraft may include four flight components that include propulsors in any configuration to stabilize lift and achieve symmetry on the electric aircraft's sagittal plane. The four propulsors may also be fixed at one angle of attack, such that the angle of attack may not be adjusted during flight. The electric aircraft also includes two pushers; a first pusher mechanically coupled to a first wing and a second pusher mechanically coupled to a second wing, wherein both pushers serve to provide forward flight to the electric aircraft. The pushers may include pusher propellers, paddle wheels, tractor propellers, and the like. The wings may include a vertical stabilizer that includes any type of fin that produces lift while the electric aircraft is in the air. The electric aircraft may also include a sensor that may include a camera configured to detect the lift and forward flight of electric aircraft. The electric aircraft may also include a flight controller that may include a computing device that may be configured to direct the electric aircraft during lift, forward flight, or combination thereof. The flight controller may also be configured to adjust speed of flight components and pushers to optimize flight, as a function of a pilot control.

Referring now to FIG. 1, is an exemplary embodiment of an electric aircraft 100 is illustrated. The electric aircraft may include an electric vertical take-off and landing (eVTOL) aircraft. As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 1, a number of aerodynamic forces may act upon eVTOL aircraft 100 during flight. Forces acting on eVTOL aircraft 100 during flight may include, without limitation, thrust, defined as a forward force produced by a propulsor of the eVTOL aircraft 100 that acts parallel to a longitudinal axis of the eVTOL aircraft. Another force acting upon eVTOL aircraft 100 may include, without limitation, drag, which may be defined as a rearward retarding force which is caused by disruption of airflow by any protruding surface of the eVTOL aircraft 100 such as, without limitation, a wing, rotor, fuselage, or the like. Drag may oppose thrust and act rearward parallel to relative wind. A further force acting upon eVTOL aircraft 100 may include, without limitation, weight, which may include a combined load of the eVTOL aircraft 100 itself, crew, baggage, and/or fuel. Weight may pull eVTOL aircraft 100 downward due to the force of gravity. An additional force acting on eVTOL aircraft 100 may include, without limitation, lift, which may act to oppose a downward force of weight and may be produced by the dynamic effect of air acting on the airfoil and/or downward thrust from a propulsor of the eVTOL aircraft. Lift generated by an airfoil may depend on speed of airflow, density of air, total area of an airfoil and/or segment thereof, and/or an angle of attack between air and the airfoil. For example, and without limitation, eVTOL aircraft 100 may be designed to be as lightweight as possible. Reducing weight of an aircraft and designing to reduce the number of components is essential to optimize the weight. To save energy, it may be useful to reduce weight of components of an eVTOL aircraft 100, including without limitation propulsors and/or propulsion assemblies.

Referring still to FIG. 1, aircraft may include at least a flight component 104. Flight component 104 may include a vertical propulsor which may further include an integrated electric propulsion assembly. For instance and without limitation, an integrated electric propulsion assembly may be consistent with disclosure of electric propulsion assembly U.S. Pat. App. Ser. No. 62/858,281 and titled “INTEGRATED ELECTRIC PROPULSION ASSEMBLY”, which is incorporated herein by reference in its entirety. “Vertical propulsor”, for the purposes of this disclosure, refers to a device that propels the aircraft in an upward direction; one of more vertical propulsors may be mounted on the front, on the wings, at the rear, and/or any suitable location. A propulsor, as used herein, is a component or device used to propel a craft by exerting force on a fluid medium, which may include a gaseous medium such as air or a liquid medium such as water. At least a vertical propulsor 104 is a propulsor that generates a substantially downward thrust, tending to propel an aircraft in a vertical direction providing thrust for maneuvers such as without limitation, vertical take-off, vertical landing, hovering, and/or rotor-based flight such as “quadcopter” or similar styles of flight. A pusher may include a forward propulsor that propels the aircraft in a forward direction. Forward propulsors may be positioned for propelling an aircraft in a “forward” direction; forward propulsor may include one or more propulsors mounted on the front, on the wings, at the rear, or a combination of any such positions. Forward propulsor may propel an aircraft forward for fixed-wing and/or “airplane”-style flight, takeoff, and/or landing, and/or may propel the aircraft forward or backward on the ground. Forward in this context is not an indication of the propulsor position on the aircraft; one or more propulsors mounted on the front, on the wings, at the rear, etc. The plurality of flight components 104 may be fixed at one angle of attack. “Angle of attack”, for the purposes of this disclosure, refers to a physical value that represents the space between the oncoming air or relative wind and a reference line on the wings or propulsors of an aircraft. The fixed angle of attack may also be static throughout the duration of the eVTOL aircraft's flight. Vertical propulsors 104 may include an adjusted and fixed angle of the vertical propulsor's blades to provide efficient angle of attack at all flight components and speed of the eVTOL 100.

With continued reference to FIG. 1, at least a first pusher 108 and a second pusher 112 as used in this disclosure may each include a forward propulsor positioned for propelling an aircraft in a “forward” direction. The pusher may include an integrated electric propulsion assembly. The integrated electric propulsion assembly may further include forward propulsor, integrated rotor, pusher propellor, paddle wheel, and the like. Integrated electric propulsion assembly includes at least a stator. Stator, as used herein, is a stationary component of a motor and/or motor assembly. In an embodiment, stator includes at least a first magnetic element. As used herein, first magnetic element is an element that generates a magnetic field. For example, first magnetic element may include one or more magnets which may be assembled in rows along a structural casing component. Further, first magnetic element may include one or more magnets having magnetic poles oriented in at least a first direction. The magnets may include at least a permanent magnet. Permanent magnets may be composed of, but are not limited to, ceramic, alnico, samarium cobalt, neodymium iron boron materials, any rare earth magnets, and the like. Further, the magnets may include an electromagnet. As used herein, an electromagnet is an electrical component that generates magnetic field via induction; the electromagnet may include a coil of electrically conducting material, through which an electric current flow to generate the magnetic field, also called a field coil of field winding. A coil may be wound around a magnetic core, which may include without limitation an iron core or other magnetic material. The core may include a plurality of steel rings insulated from one another and then laminated together; the steel rings may include slots in which the conducting wire will wrap around to form a coil. A first magnetic element may act to produce or generate a magnetic field to cause other magnetic elements to rotate, as described in further detail below. Stator may include a frame to house components including at least a first magnetic element, as well as one or more other elements or components as described in further detail below. In an embodiment, a magnetic field can be generated by a first magnetic element and can comprise a variable magnetic field. In embodiments, a variable magnetic field may be achieved by use of an inverter, a controller, or the like. In an embodiment, stator may have an inner and outer cylindrical surface; a plurality of magnetic poles may extend outward from the outer cylindrical surface of the stator. In an embodiment, stator may include an annular stator, wherein the stator is ring-shaped. In an embodiment, stator is incorporated into a DC motor where stator is fixed and functions to supply the magnetic fields where a corresponding rotor, as described in further detail below, rotates. First pusher 108 and second pusher 112 may both include an integrated propulsion assembly 100. At least a forward propulsor may include one or more propulsors mounted on the front, below the wings, above the wings. at the rear, or a combination of any such positions. At least a forward propulsor may propel an aircraft forward for fixed-wing and/or “airplane”-style flight, takeoff, and/or landing, and/or may propel the aircraft forward or backward on the ground. At least a vertical propulsor 104 and at least a forward propulsor 108 includes a thrust element. At least a thrust element may include any device or component that converts the mechanical energy of a motor, for instance in the form of rotational motion of a shaft, into thrust in a fluid medium. At least a thrust element may include, without limitation, a device using moving or rotating foils, including without limitation one or more rotors, an airscrew or propeller, a set of airscrews or propellers such as contrarotating propellers, a moving or flapping wing, or the like. At least a thrust element may include without limitation a marine propeller or screw, an impeller, a turbine, a pump-jet, a paddle or paddle-based device, or the like. As another non-limiting example, at least a thrust element may include an eight-bladed pusher propeller, such as an eight-bladed propeller mounted behind the engine to ensure the drive shaft is in compression. Propulsors may include at least a motor mechanically coupled to the at least a first propulsor as a source of thrust. A motor may include without limitation, any electric motor, where an electric motor is a device that converts electrical energy into mechanical energy, for instance by causing a shaft to rotate. At least a motor may be driven by direct current (DC) electric power; for instance, at least a first motor may include a brushed DC at least a first motor, or the like. At least a first motor may be driven by electric power having varying or reversing voltage levels, such as alternating current (AC) power as produced by an alternating current generator and/or inverter, or otherwise varying power, such as produced by a switching power source. At least a first motor may include, without limitation, brushless DC electric motors, permanent magnet synchronous at least a first motor, switched reluctance motors, or induction motors. In addition to inverter and/or a switching power source, a circuit driving at least a first motor may include electronic speed controllers or other components for regulating motor speed, rotation direction, and/or dynamic braking. Persons skilled in the art, upon reviewing the entirety of this disclosure, will be aware of various devices that may be used as at least a thrust element.

Still referring to FIG. 1, electric propulsion assembly 108 or 2012 may include a motor assembly incorporating a rotating assembly and a stationary assembly. Hub, motor inner magnet carrier and propulsor shaft may be incorporated into the rotor assembly of electric propulsion assembly which make up rotating parts of electric motor, moving between the stator poles and transmitting the motor power. As one integrated part, the rotor assembly may be inserted and removed in one piece. Stator may be incorporated into the stationary part of the motor assembly. Stator and rotor may combine to form an electric motor. In embodiment, an electric motor may, for instance, incorporate coils of wire which are driven by the magnetic force exerted by a first magnetic field on an electric current. The function of the motor may be to convert electrical energy into mechanical energy. In operation, a wire carrying current may create at least a first magnetic field with magnetic poles in a first orientation which interacts with a second magnetic field with magnetic poles oriented in the opposite direction of the first magnetic pole direction causing a force that may move a rotor in a direction. For example and without limitation, a first magnetic element 108 in electric propulsion assembly may include an active magnet. For instance and without limitation, a second magnetic element may include a passive magnet, a magnet that reacts to a magnetic force generated by a first magnetic element 108. In an embodiment, a first magnet and a second magnet, positioned around the rotor assembly, may generate magnetic fields to affect the position of the rotor relative to the stator. A controller may have an ability to adjust electricity originating from a power supply and, thereby, the magnetic forces generated, to ensure stable rotation of the rotor, independent of the forces induced by the machinery process. Electric propulsion assembly may include an impeller coupled with the shaft. An impeller, as described herein, is a rotor used to increase or decrease the pressure and flow of a fluid and/or air. Impeller may function to provide cooling to electric propulsion assembly. Impeller may include varying blade configurations, such as radial blades, non-radial blades, semi-circular blades, and airfoil blades. Impeller may further include single and/or double-sided configurations.

Still referring to FIG. 1, integrated electric propulsor assembly 100 may be mounted on a structural feature. The structural feature may include the first wing 116 and second wing 120 and the integrated electric propulsor assembly 100 may correlates to the forward propulsors of the first pusher 108 and second pusher 112. Design of integrated electric propulsion assembly 100 may enable it to be installed external to the structural member (such as a boom, nacelle, or fuselage) for easy maintenance access and to minimize accessibility requirements for the structure. This may improve structural efficiency by requiring fewer large holes in the mounting area. This design may include two main holes in the top and bottom of the mounting area to access bearing cartridge 140. Further, a structural feature may include a component of an aircraft 100. For example and without limitation structural feature may be any portion of a vehicle incorporating integrated electric propulsion assembly 100, including any vehicle as described below. As a further non-limiting example, a structural feature may include without limitation a wing, a spar, an outrigger, a fuselage, or any portion thereof; persons skilled in the art, upon reviewing the entirety of this disclosure, will be aware of many possible features that may function as at least a structural feature. At least a structural feature may be constructed of any suitable material or combination of materials, including without limitation metal such as aluminum, titanium, steel, or the like, polymer materials or composites, fiberglass, carbon fiber, wood, or any other suitable material. As a non-limiting example, at least a structural feature may be constructed from additively manufactured polymer material with a carbon fiber exterior; aluminum parts or other elements may be enclosed for structural strength, or for purposes of supporting, for instance, vibration, torque, or shear stresses imposed by at least a propulsor 112. Persons skilled in the art, upon reviewing the entirety of this disclosure, will be aware of various materials, combinations of materials, and/or constructions techniques.

With continued reference to FIG. 1, a first wing 116 may be used as a structure for a pair of vertical propulsors 104 and a first forward propulsor 108 to be configured onto it. The forward propulsor 108 may be configured above the first wing 116. In an embodiment, a forward propulsor 108 above the first wing 116 may provide the eVTOL 100 the advantage of offering maximum clearance from the ground and keeping the forward propulsor 108 well clear from the cockpit of the electric aircraft. The embodiment may also increase the wing lift-to-drag ratio, high-lift capabilities, wing efficiency, and to reduce flyover noise. The forward propulsor 108 may also be attached below the first wing 116. In an embodiment, a pusher 108 below the first wing 116 may provide the eVTOL 100 the advantage of increasing the pusher's efficiency. This embodiment also allows for the placement of the pusher 108 to be below a pair of vertical propulsors 104 lying on the same sagittal plane that may increase the aerodynamics of the first wing 116 as the vertical propulsors 104 and forward propulsor 108 would take less space of the wing of the electric aircraft. The eVTOL 100 also includes a vertically symmetrical configuration of the first wing 116, forward propulsor 108, and the pair of vertical propulsors 104 wherein the embodiments mentioned above can be applied to the second wing 120, second forward propulsor, 112, and a pair of vertical stabilizers 104. Persons skilled in the art, upon reviewing the entirety of this disclosure, will be aware of various alternative or additional forms and/or configurations that the vertical propulsors and forward propulsors may take or exemplify as consistent with this disclosure.

With continued reference to FIG. 1, each wing of the electric aircraft may include a vertical stabilizer 214. A “vertical stabilizer”, for the purposes of this disclosure, is a component or structure designed to reduce sideways movement of an aircraft and provide the aircraft directional stability. One of ordinary skill in the art would appreciate, after reviewing the entirety of this disclosure, that vertical stabilizer may include a plurality of types, but not limited to, wingtip device, wingtip fence, raked wingtip, canted winglet, sharklet, blended winglet, and the like. The vertical stabilizer 124 may produce lift while the eVTOL 100 is moving in the air. In an embodiment, the vertical stabilizer 124 may be configured to maximize the reduction of induced drag of an electric aircraft. For example, winglets increase the effective aspect ratio of the wing, changing the pattern and magnitude of the vorticity in the vortex pattern of a wingtip vortex. Wingtip vortex may include a circular pattern of rotating air left behind a wing of an aircraft as it generates lift. Persons skilled in the art, upon reviewing the entirety of this disclosure, will be aware of various consequences of a wingtip vortex that a vertical stabilizer may induce as consistent with this disclosure. A reduction is achieved in the kinetic energy in the circular air flow, which reduces the amount of fuel expended to perform work upon the spinning air.

With continued reference to FIG. 1, during flight, a number of forces may act upon the eVTOL aircraft. Forces acting on an electric aircraft 100 during flight may include thrust, the forward force produced by the rotating element of the aircraft 100 and acts parallel to the longitudinal axis. Drag may be defined as a rearward retarding force which is caused by disruption of airflow by any protruding surface of the aircraft 100 such as, without limitation, the wing, rotor, and fuselage. Drag may oppose thrust and acts rearward parallel to the relative wind. Another force acting on aircraft 100 may include weight, which may include a combined load of the aircraft 100 itself, crew, baggage, and fuel. Weight may pull aircraft 100 downward due to the force of gravity. An additional force acting on aircraft 100 may include lift, which may act to oppose the downward force of weight and may be produced by the dynamic effect of air acting on the airfoil and/or downward thrust from at least a propulsor. Lift generated by the airfoil may depends on speed of airflow, density of air, total area of an airfoil and/or segment thereof, and/or an angle of attack between air and the airfoil.

With continued reference to FIG. 1, at least a portion of an eVTOL aircraft may include at least a propulsor. A propulsor, as used herein, is a component or device used to propel a craft by exerting force on a fluid medium, which may include a gaseous medium such as air or a liquid medium such as water. In an embodiment, when a propulsor twists and pulls air behind it, it will, at the same time, push an aircraft forward with an equal amount of force. The more air pulled behind an aircraft, the greater the force with which the aircraft is pushed forward. Propulsor may include any device or component that consumes electrical power on demand to propel an eVTOL aircraft in a direction or other vehicle while on ground or in-flight.

With continued reference to FIG. 1, in an embodiment, at least a portion of the aircraft may include a propulsor, the propulsor may include a propeller, a blade, or any combination of the two. The function of a propeller is to convert rotary motion from an engine or other power source into a swirling slipstream which pushes the propeller forwards or backwards. The propulsor may include a rotating power-driven hub, to which are attached several radial airfoil-section blades such that the whole assembly rotates about a longitudinal axis. The blade pitch of the propellers may, for example, be fixed, manually variable to a few set positions, automatically variable (e.g. a “constant-speed” type), or any combination thereof. In an embodiment, propellers for an aircraft are designed to be fixed to their hub at an angle similar to the thread on a screw makes an angle to the shaft; this angle may be referred to as a pitch or pitch angle which will determine the speed of the forward movement as the blade rotates.

With continued reference to FIG. 1, in an embodiment, a propulsor can include a thrust element which may be integrated into the propulsor. The thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like.

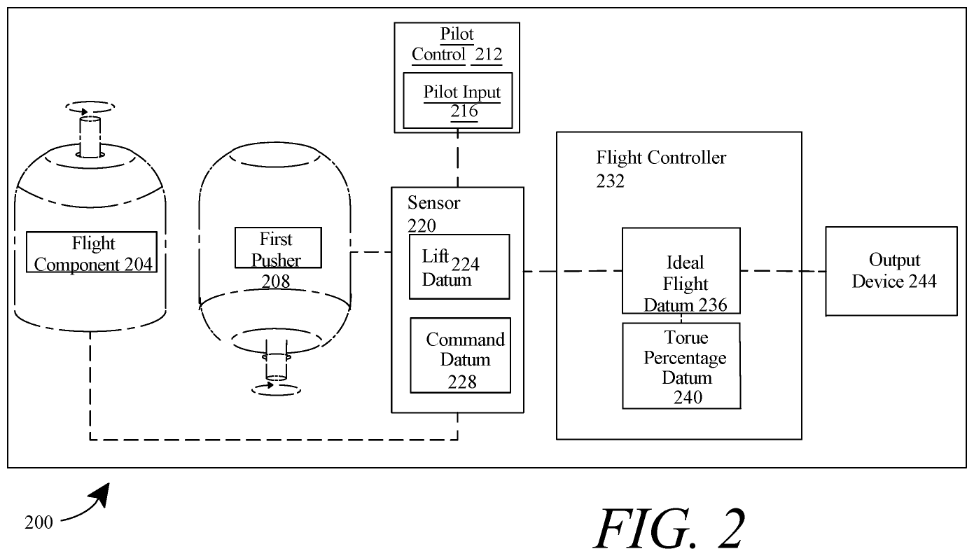

Referring now to FIG. 2, an exemplary embodiment of a system 200 for the aircraft components configured for use in electric aircraft for fixed-pitch flight is illustrated in block diagram form. System 200 may include a sensor 220 that may be communicatively coupled to at least a pilot control 212, flight component 204, and pusher 208. “Communicative coupling”, for the purposes of this disclosure, refers to two or more components electrically, or otherwise connected and configured to transmit and receive signals from one another. Signals may include electrical, electromagnetic, visual, audio, radio waves, or another undisclosed signal type alone or in combination. At least a sensor 220 communicatively connected to at least a pilot control 212 may include a sensor disposed on, near, around or within at least pilot control 212. At least a sensor 220 may include a motion sensor. “Motion sensor”, for the purposes of this disclosure refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. At least a sensor 220 may include, torque sensor, gyroscope, accelerometer, torque sensor, magnetometer, inertial measurement unit (IMU), pressure sensor, force sensor, proximity sensor, displacement sensor, vibration sensor, among others. At least a sensor 220 may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings. At least a sensor 220 is configured to detect pilot input 216 from at least pilot control 212. At least pilot control 212 may include a throttle lever, inceptor stick, collective pitch control, steering wheel, brake pedals, pedal controls, toggles, joystick. One of ordinary skill in the art, upon reading the entirety of this disclosure would appreciate the variety of pilot input controls that may be present in an electric aircraft consistent with the present disclosure. Inceptor stick may be consistent with disclosure of inceptor stick in U.S. patent application Ser. No. 17/001,845 and titled “A HOVER AND THRUST CONTROL ASSEMBLY FOR DUAL-MODE AIRCRAFT”, which is incorporated herein by reference in its entirety. Collective pitch control may be consistent with disclosure of collective pitch control in U.S. patent application Ser. No. 16/929,206 and titled “HOVER AND THRUST CONTROL ASSEMBLY FOR DUAL-MODE AIRCRAFT”, which is incorporated herein by reference in its entirety. At least pilot control 212 may be physically located in the cockpit of the aircraft or remotely located outside of the aircraft in another location communicatively connected to at least a portion of the aircraft. “Communicatively couple”, for the purposes of this disclosure, is a process whereby one device, component, or circuit is able to receive data from and/or transmit data to another device, component, or circuit; communicative coupling may be performed by wired or wireless electronic communication, either directly or by way of one or more intervening devices or components. In an embodiment, communicative coupling includes electrically coupling an output of one device, component, or circuit to an input of another device, component, or circuit. Communicative coupling may be performed via a bus or other facility for intercommunication between elements of a computing device. Communicative coupling may include indirect connections via “wireless” connection, low power wide area network, radio communication, optical communication, magnetic, capacitive, or optical coupling, or the like. At least pilot control 212 may include buttons, switches, or other binary inputs in addition to, or alternatively than digital controls about which a plurality of inputs may be received. At least pilot control 212 is configured to receive pilot input 216. Pilot input 216 may include a physical manipulation of a control like a pilot using a hand and arm to push or pull a lever, or a pilot using a finger to manipulate a switch. Pilot input 216 may include a voice command by a pilot to a microphone and computing system consistent with the entirety of this disclosure.

With continued reference to FIG. 2, the sensor 220 may also be communicatively coupled to a plurality of flight components 204 and pushers 208. Flight component 204 may include the vertical propulsor 204 and pusher 208 may include the forward propulsor 208 as described previously. For example, the motion sensor may capture the distance the eVTOL and its flight component 204 and pusher 208 is from the ground. Flight component 204 may and pusher 208 may further include an electrical machine that converts electrical energy into mechanical energy, such a motor. A motor may include without limitation, any electric motor, where an electric motor is a device that converts electrical energy into mechanical energy, for instance by causing a shaft to rotate. A motor may be driven by direct current (DC) electric power; for instance, a motor may include a brushed DC motor or the like. A motor may be driven by electric power having varied or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor. Most electric motors operate through the interaction between the motor's magnetic field and electric current in a wire winding to generate force in the form of torque applied on the motor's shaft. Electric motors can be powered by direct current (DC) sources, such as from batteries, motor vehicles or rectifiers, or by alternating current (AC) sources, such as a power grid, inverters, or electrical generators. An electric generator is mechanically identical to an electric motor, but operates with a reversed flow of power, converting mechanical energy into electrical energy. Persons skilled in the art, upon reviewing the entirety of this disclosure, will be aware of various alternative or additional forms and/or configurations that a motor may take or exemplify as consistent with this disclosure.

In an embodiment, flight component and pusher may include a propulsor, the propulsor may include a propeller, a blade, or any combination of the two. The function of a propeller is to convert rotary motion from an engine or other power source into a swirling slipstream which pushes the propeller forwards or backwards. The propulsor may include a rotating power-driven hub, to which are attached several radial airfoil-section blades such that the whole assembly rotates about a longitudinal axis. The blade pitch of the propellers may, for example, be fixed, manually variable to a few set positions, automatically variable (e.g. a “constant-speed” type), or any combination thereof. In an embodiment, propellers for an aircraft are designed to be fixed to their hub at an angle similar to the thread on a screw makes an angle to the shaft; this angle may be referred to as a pitch or pitch angle which will determine the speed of the forward movement as the blade rotates.

With continued reference to FIG. 2, at least a sensor 220 is configured to generate, as a function of pilot input 216, flight component 204, and pusher 208, a lift datum 224 and command datum 228. A “lift datum”, for the purposes of this disclosure, refers to electronic values representing at least an element of data correlated to the flight component 204 and pusher 208. For example, the element may include the speed or revolutions per minute (RPM) of the flight component and pusher blades or other components of the life. Lift datum 224 may include a torque datum. In a non-limiting embodiment, sensor 220 may detect the torque produced by pusher 208 and translate that torque value into an electrical signal that represents that value for use in later processing or steps consistent with the entirety of this disclosure. A “command datum”, for the purposes of this disclosure, refers to an electronic signal representing at least an element of data correlated to pilot input 216 representing a desired change in aircraft conditions as described in the entirety of this disclosure. A “datum”, for the purposes of this disclosure, refers to at least an element of data identifying and/or a pilot input or command. At least pilot control 212 may be communicatively connected to any other component presented in system, the communicative connection may include redundant connections configured to safeguard against single-point failure. Pilot input 216 may indicate a pilot's desire to change the heading or trim of an electric aircraft. Pilot input 216 may indicate a pilot's desire to change an aircraft's pitch, roll, yaw, or throttle. “Pitch”, for the purposes of this disclosure refers to an aircraft's angle of attack, that is the difference between the aircraft's nose and the horizontal flight trajectory. For example, an aircraft pitches “up” when its nose is angled upward compared to horizontal flight, like in a climb maneuver. In another example, the aircraft pitches “down”, when its nose is angled downward compared to horizontal flight, like in a dive maneuver. “Roll” for the purposes of this disclosure, refers to an aircraft's position about its longitudinal axis, that is to say that when an aircraft rotates about its axis from its tail to its nose, and one side rolls upward, like in a banking maneuver. “Yaw”, for the purposes of this disclosure, refers to an aircraft's turn angle, when an aircraft rotates about an imaginary vertical axis intersecting the center of the earth and the fuselage of the aircraft. “Throttle”, for the purposes of this disclosure, refers to an aircraft outputting an amount of thrust from a propulsor. Pilot input 216, when referring to throttle, may refer to a pilot's desire to increase or decrease thrust produced by at least a propulsor. Command datum 228 may include an electrical signal. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. At least a sensor 220 may include circuitry, computing devices, electronic components, or a combination thereof that translates pilot input 216 into at least an electronic signal command datum 228 configured to be transmitted to another electronic component.

With continued reference to FIG. 2, system 200 includes flight controller 232. Flight controller 232 is communicatively connected to at least a pilot control 212, flight component 204, pusher 208, and a sensor 220. Flight controller 232 further takes in information from onboard and offboard sensors that measure environmental conditions like airspeed, angle of attack, and air density, as well as aircraft conditions like battery level. Communicative coupling may be consistent with any embodiment of communicative coupling as described herein. Flight controller 232 is configured to generate an ideal flight datum 236. Flight controller may mix, refine, adjust, redirect, combine, separate, or perform other types of signal operations to translate pilot desired trajectory into aircraft maneuvers. Flight controller, for example, may take in a pilot input of moving an inceptor stick, the signal from that move may be sent to flight controller, which performs any number or combinations of operations on those signals, then sends out output signals to any number of aircraft components that work in tandem or independently to maneuver the aircraft in response to the pilot input. Flight controller may condition signals such that they can be sent and received by various components throughout the electric aircraft.

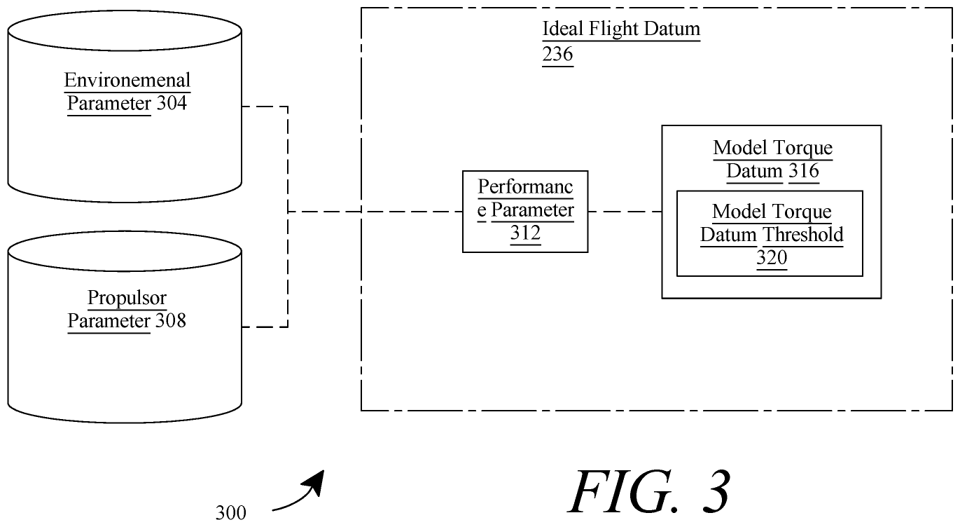

With continued reference to FIG. 3, flight controller 232 may be configured to generate torque percentage datum 240. A “torque percentage datum”, for the purposes of this disclosure, is an element of data representing the actual torque produced by at least a propulsor compared to the modeled torque output of the same ideal propulsor given the same performance parameters. For example, in a nonlimiting embodiment, flight controller 232 may generate torque percentage datum 240 by dividing lift datum 324 by model torque datum 316, wherein lift datum 324 is detected by sensor 220 from pusher 208 and model torque datum 316 generated from receiving ideal flight datum 236. Performance parameter 312 would replicate the conditions that propulsor 304 is operating under. For example, in a nonlimiting embodiment, performance parameter 312 would include air density, temperature, humidity, propulsor type and electrical input that match exactly values the actual aircraft is operating under, and therefore model torque datum 316 would represent an ideal propulsor in those conditions. Torque percentage datum 240, in other words, would represent the torque output of an actual propulsor versus the same propulsor in an ideal world, giving way to a percentage of ideal torque. Torque percentage datum 240 may be represented as a fraction, percentage, decimal, or other mathematical representation of part of a whole. In a non-limiting embodiment, torque percentage datum may be correlated with the ideal flight datum 236 to allocate torque to the flight components of the electric aircraft or display a percentage to a user that the user may command the electric aircraft to optimize flight. One of ordinary skill in the art, after reviewing the entirety of this disclosure would appreciate that there are virtually limitless visual, auditory, haptic, or other types of representations that torque percentage datum 240 may take.

With continued reference to FIG. 2, flight controller 232 is configured to generate, as a function of the command datum 228, lift datum 224, and the ideal flight datum 236, Ideal flight datum 236 correlated to the pilot input 216. Ideal flight datum 236 may be an electrical signal that is consistent with any electrical signal as described in this disclosure. Ideal flight datum 236 may include signals for the components of the electric aircraft to adjust in respect to the fixed angle of attack, such as the RPM for each aircraft component the pilot must command for increased efficient vertical lift, forward thrust, or combination thereof. Ideal flight datum 236 may further include a command to move the eVTOL while moving in the air with respects to the fixed angle of attack of the flight components 204 and pusher 208 prior to flight. In a non-limiting embodiment, the ideal flight datum may include a torque allocation for each individual flight component and forward pushers to be commanded by a pilot to optimize the lift and/or flight of the electric aircraft.

Still referring to FIG. 2, flight controller 232 may include and/or communicate with any computing device, including without limitation a microcontroller, microprocessor, digital signal processor (DSP) and/or system on a chip (SoC). Flight controller may be programmed to operate electronic aircraft to perform at least a flight maneuver; at least a flight maneuver may include takeoff, landing, stability control maneuvers, emergency response maneuvers, regulation of altitude, roll, pitch, yaw, speed, acceleration, or the like during any phase of flight. At least a flight maneuver may include a flight plan or sequence of maneuvers to be performed during a flight plan. Flight controller may be designed and configured to operate electronic aircraft via fly-by-wire. Flight controller is communicatively connected to each propulsor; as used herein, flight controller is communicatively connected to each propulsor where flight controller is able to transmit signals to each propulsor and each propulsor is configured to modify an aspect of propulsor behavior in response to the signals. As a non-limiting example, flight controller may transmit signals to a propulsor via an electrical circuit connecting flight controller to the propulsor; the circuit may include a direct conductive path from flight controller to propulsor or may include an isolated coupling such as an optical or inductive coupling. Alternatively, or additionally, flight controller may communicate with a propulsor of plurality of propulsors 204 using wireless communication, such as without limitation communication performed using electromagnetic radiation including optical and/or radio communication, or communication via magnetic or capacitive coupling. Vehicle controller may be fully incorporated in an electric aircraft containing a propulsor and may be a remote device operating the electric aircraft remotely via wireless or radio signals, or may be a combination thereof, such as a computing device in the aircraft configured to perform some steps or actions described herein while a remote device is configured to perform other steps. Persons skilled in the art will be aware, after reviewing the entirety of this disclosure, of many different forms and protocols of communication that may be used to communicatively couple flight controller to propulsors. Persons skilled in the art, upon reviewing the entirety of this disclosure, will be aware of various ways to monitor resistance levels and apply resistance to linear thrust control, as used and described herein.

Flight controller 232 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Fall back flight control system 200 may include a single computing device operating independently, or may include two or more computing device operating in concert, in parallel, sequentially or the like; two or more computing devices may be included together in a single computing device or in two or more computing devices. Flight controller 232 may interface or communicate with one or more additional devices as described below in further detail via a network interface device. Network interface device may be utilized for connecting flight controller 232 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Flight controller 232 may include but is not limited to, for example, a computing device or cluster of computing devices in a first location and a second computing device or cluster of computing devices in a second location. Fall back flight control system 200 may include one or more computing devices dedicated to data storage, security, distribution of traffic for load balancing, and the like. Flight controller 232 may distribute one or more computing tasks as described below across a plurality of computing devices of computing device, which may operate in parallel, in series, redundantly, or in any other manner used for distribution of tasks or memory between computing devices. Flight controller 232 may be implemented using a “shared nothing” architecture in which data is cached at the worker, in an embodiment, this may enable scalability of flight controller 232 and/or computing device.

Flight controller 232 may be designed and/or configured to perform any method, method step, or sequence of method steps in any embodiment described in this disclosure, in any order and with any degree of repetition. For instance, flight controller 232 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller 232 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing. Flight controller 232, as well as any other component present within disclosed systems, as well as any other components or combination of components may be connected to a controller area network (CAN) which may interconnect all components for signal transmission and reception.

With continued reference to FIG. 2, system 200 may include an output device 244 which may be mechanically coupled to the electric aircraft. “Output device”, for the purposes of this disclosure, refers to a visual apparatus that is comprised of compact flat panel designs, liquid crystal display, organic light-emitting diode, or combination thereof to present visual information superimposed on spaces. Output device 244 may include a graphical user interface (GUI), multi-functional display (MFD), primary flight display (PFD), gauges, dials, screens, touch screens, speakers, haptic feedback device, live feed, window, combination thereof, or another display type not listed here. In a nonlimiting embodiment, output device 244 may include a mobile computing device like a smartphone, tablet, computer, laptop, client device, server, a combination thereof, or another undisclosed display alone or in combination. Output device 244 may be disposed in at least a portion of a cockpit of an electric aircraft. Output device 244 may be a heads-up display (HUD) disposed in goggles, glasses, eye screen, or other headwear a pilot or user may be wearing. Output device 244 may include augmented reality, virtual reality, or combination thereof. Output device may be configured to present, to a suer, the ideal flight datum 236. Ideal flight datum may include any ideal flight datum as described herein. In a non-limiting embodiment, the ideal flight datum may display the ideal torque each flight component a pilot may command. A person of ordinary skill in the art would appreciate the information being displayed may be easily understood by a pilot.

Referring now to FIG. 3, exemplary embodiment 300 is illustrated including ideal flight datum 236. Ideal flight datum 236 may be any ideal flight datum as disclosed herein. Ideal flight datum may include one or more databases, workbooks, scripts, programs, codes, spreadsheets, list of steps, or other instructions disposed within a computing device configured to take inputs or otherwise include performance parameter 312 and generate model torque datum 316 and model torque datum threshold 320. For example, ideal flight datum 236 may include a component, value, or grouping of components or values that may individually control the flight components or pushers that may, as a consequence control the movement of the electric aircraft by taking in signals from a pilot and output signals to at least a propulsor and other portions of the electric aircraft. In a nonlimiting embodiment, ideal flight datum 236 may do the necessary processing to generate model torque datum 316. In another nonlimiting embodiment, flight controller 232 may be configured to generate model torque datum 316 as a function of receiving ideal flight datum 236. Model torque datum 316 may be any model torque datum as disclosed herein. Model torque datum threshold 320 may include maximum and minimum values as disclosed herein. For example, in nonlimiting embodiments, torque percentage datum 240 may be calculated by flight controller 232 as a function of lift datum 324 and model torque datum 316. Since model torque datum 316 includes model torque datum threshold 320, flight controller 232 may be configured to detect that lift datum 324 was less than a minimum or greater than a maximum torque value associated with model torque datum 316 and alert a pilot or user to this, adjust aircraft controls, adjust propulsor controls, or trigger detection of an obstruction with a flight component or pusher to assess the cause of the lower or higher torque value.

Still referring to FIG. 3, ideal flight datum 236 may include at least a performance parameter 312. Ideal flight datum 236 may be a set of data corresponding to a virtual propulsor's torque output. Ideal flight datum 236 may be a computer program or computer application that represents propulsor torque performance given a certain set of conditions. This set of conditions includes performance parameter 312. Performance parameter 312 may be environmental such as air density, air speed, true airspeed, relative airspeed, temperature, humidity level, and weather conditions, among others. Performance parameter 312 may include propulsor parameters that define a propulsors physical characteristics and/or specifications such as material properties, electrical characteristics, propulsor type, weight, geometry, speed, and revolutions per minute (rpm), among others. Performance parameter 312 may include velocity and/or speed in a plurality of ranges and direction such as vertical speed, horizontal speed, changes in angle or rates of change in angles like pitch rate, roll rate, yaw rate, or a combination thereof, among others.

With continued reference to FIG. 3, exemplary embodiment 200 may include performance parameter 312. Performance parameter 312 may be any performance parameter as disclosed herein. Performance parameter 312 may include environmental parameter 304. Environmental parameter may be any environmentally based performance parameter as disclosed herein. Environment parameter 204 may include, without limitation, time, pressure, temperature, air density, altitude, gravity, humidity level, airspeed, angle of attack, and debris, among others. Environmental parameters 204 may be stored in any suitable datastore consistent with this disclosure. Environmental parameters 204 may include latitude and longitude, as well as any other environmental condition that may affect propulsor 304 performance. Performance parameter 312 may include propulsor parameter 308. Propulsor parameter 308 may be any propulsor parameter as disclosed herein. Propulsor parameter 308 may include propulsor type, size, specifications, material selection, weight, orientation, friction, lubrication, component and subsystem characteristics, electrical load, fuel type, wear, fatigue, stress, strain, or any other parameter that may affect a propulsor's ability to output torque. One of ordinary skill in the art, after reviewing the entirety of this disclosure, would appreciate the propulsor parameters associated with every propulsor type, and these examples in no way limit the plurality of values that propulsor parameter 308 may take. Propulsor parameter 308 may be stored in any suitable datastore consistent with the disclosure.

Still referring to FIG. 3, flight controller 232 may be configured to generate model torque datum 316 including model torque datum threshold 320. A “model torque datum”, for the purposes of this disclosure, is an element of data that represents an ideal torque output form an ideal flight datum. One of ordinary skill in the art, after reviewing the entirety of this disclosure, would appreciate that model torque datum 316 is the torque output an ideal virtual torque data from a perfect propulsor given performance parameter 312 of a plurality of performance parameters. For example, in a nonlimiting embodiment, ideal flight datum 236 may include performance parameter 312 including air density, propulsor type, electrical input, and rpm. Model torque datum 316 may be generated by flight controller 232 to represent what a perfect (ideal) propulsor would output as torque given those performance parameters 312. Model torque datum threshold 320 includes a range of acceptable torque values associated with model torque datum 316. Model torque datum threshold 320 may be a minimum and maximum torque value associated with model torque datum 316. Flight controller 232 may be configured to detect if output torque datum is outside model torque datum threshold 320, which may then trigger detection of datums consistent with this disclosure.

Still referring to FIG. 3, flight controller 232 may utilize stored data to generate model torque datum 316. Stored data may be past torque outputs related to performance parameter 312 desired for the instant model in an embodiment of the present invention. Stored data may be input by a user, pilot, support personnel, or another. Stored data may include algorithms and machine-learning processes that may generate model torque datum 316 considering at least a performance parameter 312. The algorithms and machine-learning processes may be any algorithm or machine-learning processes as described herein. Training data may be columns, matrices, rows, blocks, spreadsheets, books, or other suitable datastores or structures that contain correlations between past torque outputs to performance parameters. Training data may be any training data as described below. Training data may be past measurements detected by any sensors described herein or another sensor or suite of sensors in combination. Training data may be detected by onboard or offboard instrumentation designed to detect output torque and performance parameters as described herein. Training data may be uploaded, downloaded, and/or retrieved from a server prior to flight. Training data may be generated by a computing device that may simulate torque outputs and correlated performance parameters suitable for use by the flight controller 232 in an embodiment of the present invention. Flight controller 232 and/or another computing device as described in this disclosure may train one or more machine-learning models using the training data as described in this disclosure. Training one or more machine-learning models consistent with the training one or more machine learning modules as described in this disclosure. Algorithms and machine-learning processes may include any algorithms or machine-learning processes as described herein. Training data may be columns, matrices, rows, blocks, spreadsheets, books, or other suitable datastores or structures that contain correlations between torque measurements to obstruction datums. Training data may be any training data as described below. Training data may be past measurements detected by any sensors described herein or another sensor or suite of sensors in combination. Training data may be detected by onboard or offboard instrumentation designed to lift datum and command datum as described herein. Training data may be uploaded, downloaded, and/or retrieved from a server prior to flight. Training data may be generated by a computing device that may simulate torque outputs from flight components and correlated performance parameters suitable for use by the flight controller 232 in an embodiment of the present invention. Flight controller 232 and/or another computing device as described in this disclosure may train one or more machine-learning models using the training data as described in this disclosure. Training one or more machine-learning models consistent with the training one or more machine learning modules as described in this disclosure.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

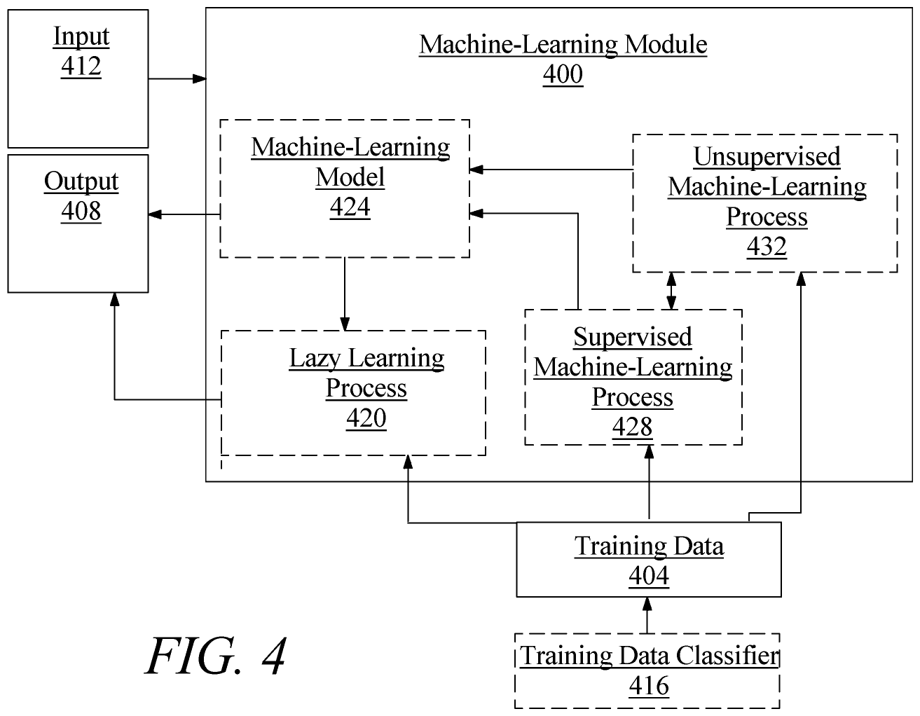

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative example, environmental parameter 304 and propulsor parameter 308 may be inputs and an ideal flight datum 236 may be an output.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to classes of performance for ideal flight datum.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs and outputs as described above in this disclosure, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

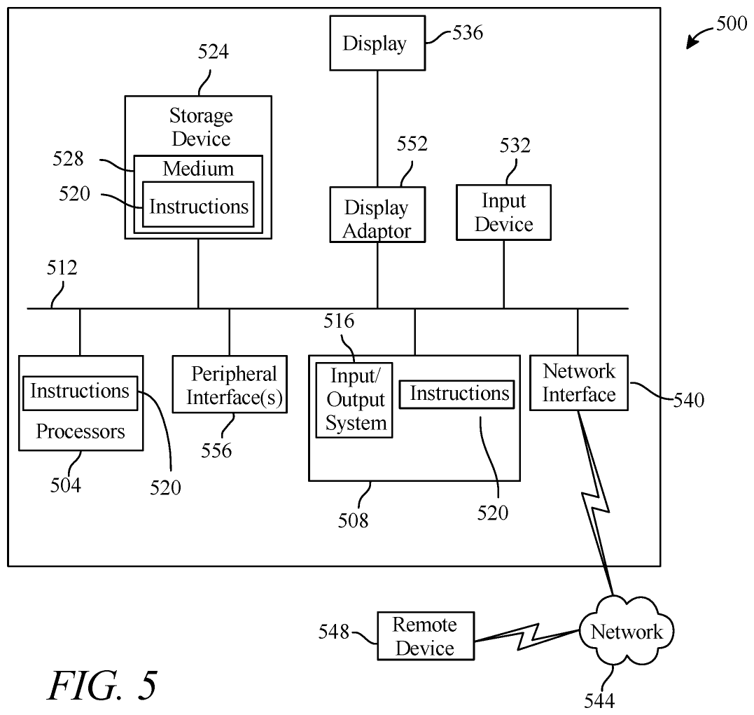

FIG. 5 shows a diagrammatic representation of one embodiment of a computing device in the exemplary form of a computer system 500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Processor 504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 504 may be organized according to Von Neumann and/or Harvard architecture as a non-limiting example. Processor 504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 508 may include various components (e.g., machine-readable media) including, but not limited to, a random-access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve systems according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A system for an electric aircraft with fixed pitch lift, wherein the system comprises:
a flight component or a plurality of flight components mechanically coupled to the electric aircraft, wherein each flight component is configured to provide lift to the electric aircraft;
a first pusher mechanically coupled to a first wing of the electric aircraft, wherein the first pusher is configured to provide forward flight to the electric aircraft; and
a second pusher mechanically coupled to a second wing of the electric aircraft, wherein the second pusher is configured to provide forward flight to the electric aircraft;
a sensor, the sensor configured to:
detect vertical lift off and forward flight from a pilot input; and
generate, as a function of the pilot input, a command datum;
a flight controller, the flight controller including a computing device, the computer device configured to:
receive the command datum; and
direct the electric aircraft, as a function of the command datum.

2. The system of claim 1, wherein the electric aircraft is an electric vertical take-off and landing aircraft (eVTOL).

3. The system of claim 1, wherein the flight controller is configured to adjust the speed of the flight components and pushers to optimize flight that is detected by the pilot input from at least a pilot control.

4. The system of claim 3, wherein the pilot control is communicatively coupled at least a component of the electric aircraft.

5. The system of claim 4, wherein the pilot control is communicatively coupled to the plurality of flight components, first pusher, and second pusher.

6. The system of claim 1, wherein the sensor is configured to generate lift datum and command datum as functions of the pilot input, flight components, and pushers.

7. The system of claim 1, wherein the flight controller is configured to generate an output datum.

8. The system of claim 1, wherein an optimal flight datum is generated, as a function of the output datum and flight controller.

9. The system of claim 1, wherein the electric aircraft is powered only by electricity.

10. The system of claim 1, wherein the electric aircraft includes an electric power source.

11. The system of claim 9, wherein the electric power source includes a plurality of battery units.

12. The system of claim 1, wherein the electric aircraft is powered by at least one electric motor.

13. The system of claim 1, wherein each flight component includes a vertical propulsor.

14. The system of claim 1, wherein the plurality of the flight components is fixed at one angle of attack.

15. The system of claim 14, wherein the angle of attack is not adjusted during flight.

16. The system of claim 1, wherein the first pusher and second pusher each includes an integrated propulsion assembly.

17. The system of claim 16, wherein the assembly includes a forward propulsor, integrated rotor, pusher propellor, paddle wheel, and the like.

18. The system of claim 1, wherein the first wing and second wing of the electric aircraft each includes a vertical stabilizer that produces lift during flight.

19. The system of claim 1, wherein the first pusher and second pusher are configured below or above the first wing and second wing of the electric aircraft.

20. The system of claim 20, wherein the first pusher and second pusher are configured below the flight components on the same sagittal plane.
